(19) United States
(12) Patent Application Publication
(10) Pub. No.: US 2012/0055169 A1
(43) Pub. Date: Mar. 8, 2012

(54) TURBINE ENGINE COMPRISING AN EXHAUST-GAS GUIDE CONE WITH A SOUND SUPPRESSOR

(75) Inventors: Eric Jean-Louis Bouty, Pau (FR); Pierre-Luc Regaud, Pau (FR); Antoine Vallon, Pau (FR)

(73) Assignee: TURBOMECA, Bordes (FR)

(21) Appl. No.: 13/319,125

(22) PCT Filed: May 27, 2010
(86) PCT No.: PCT/EP2010/057363

§ 371 Date: Nov. 7, 2011

(30) Foreign Application Priority Data
May 27, 2009 (FR) 0953495

(51) Int. Cl. F02C 3/10

(52) U.S. Cl. 60/791

(57) ABSTRACT

A gas turbine engine, in which gases flow upstream to downstream, including a combustion chamber, a high-pressure turbine placed downstream from the combustion chamber, arranged so as to receive combustion gases from the combustion chamber, a free turbine, and an exhaust-gas guide cone attached to the free turbine downstream from the free turbine, the turbine engine emitting sound waves during operation. The guide cone includes a sound suppressor, for example with a Helmholtz resonator structure, with a resonant cavity and a resonator neck in communication with an opening, arranged so as to suppress the sound waves emitted by the turbine engine.

The invention relates to the field of free turbine gas turbine engines and more particularly to the attenuation of the noise generated by a helicopter engine.

Hereafter, the terms “upstream” and “downstream” are defined in relation to the direction in which the gases circulate through the helicopter engine, the gases circulating from upstream to downstream in said engine.

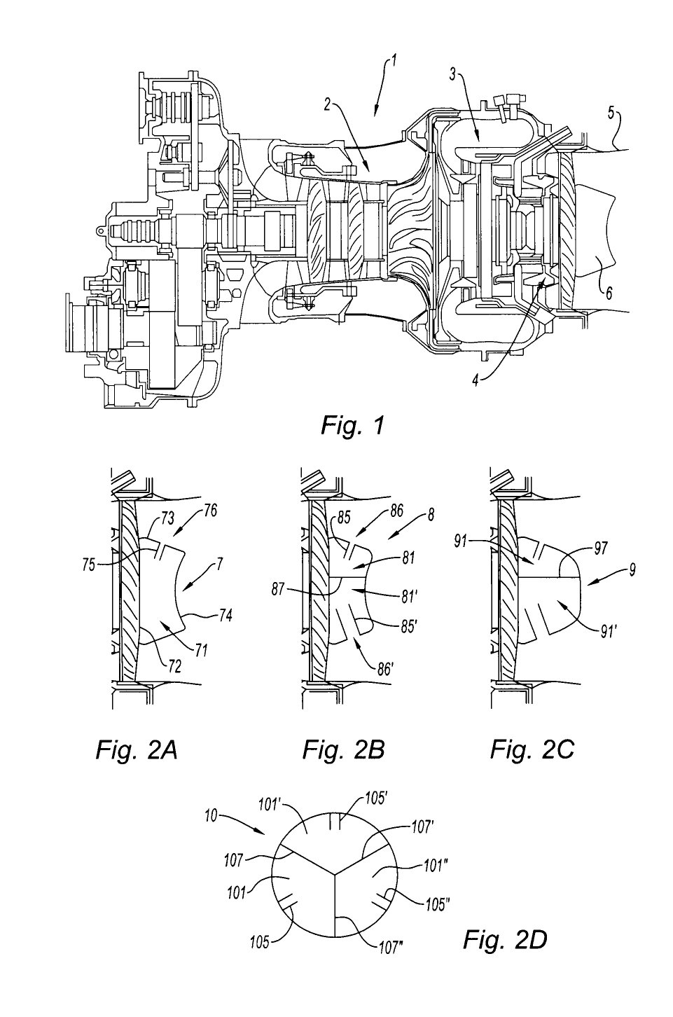

A helicopter engine, particularly a turbine engine as depicted in FIG. 1, conventionally comprises, from upstream to downstream, a compressor 2, an annular combustion chamber 3, a high-pressure turbine, and an axial free turbine 4 that recovers the energy of the combustion to drive the wing structure of the helicopter, the exhaust gases resulting from the combustion being discharged from the engine via an exhaust nozzle 5 formed downstream of the free turbine 4.

The free turbine 4 ends at its downstream end in an axial frustoconical component 6 and a nozzle, this assembly performing a function of guiding the stream of exhaust gases to ensure that the stream flows aerodynamically as it leaves the free turbine 4.

As it operates, a helicopter engine generates sound waves which form the engine noise. The engine noise is a significant component in the overall acoustic emissions of a helicopter. In order to reduce the noise of a helicopter, attempts are made to reduce the inherent engine noise.

The sound waves, emitted by the engine on the downstream side, are generated chiefly during the combustion and during the rotation of the turbines. The sound waves have different frequencies comprised within the audible range from 20 Hz to 20 kHz. The low-frequency sound waves, that is to say waves at frequencies below 400 Hz, make a significant contribution to helicopter engine noise.

“Noise suppressor” systems that attenuate the sound waves emitted by the engine are already known. A noise suppressor system according to the prior art is generally in the form of an external module mounted downstream of the engine. Aside from being very bulky, such a noise suppression system has the disadvantage of being remote from the source of noise.

It is desirable to incorporate the noise suppression system directly into the engine so as to increase the competitiveness of the engine as such in terms of noise. However, such incorporation presents numerous technical difficulties given that the components of the engine are under great both mechanical and thermal stress. Incorporating a noise suppression system into a helicopter engine represents a great technological challenge.

To this end, the invention relates to a gas turbine engine through which gases flow from upstream to downstream, comprising a combustion chamber, a high-pressure turbine, a free turbine positioned downstream of the high-pressure turbine designed to receive combustion gases emanating from said combustion chamber, and a cone for guiding the exhaust gases which is fixed to said free turbine downstream thereof, the turbine engine emitting sound waves as it operates, which turbine engine is characterized in that the guide cone comprises a sound attenuator designed to attenuate the sound waves emitted by the turbine engine.

The guide cone simultaneously performs a function of guiding the exhaust gases and a function of attenuating the sound waves emitted by the engine, making it possible to obtain an engine that performs well, and is less noisy, while at the same time keeping a small bulk and an acceptable mass.

According to a preferred form of the invention, the noise attenuator has a Helmholtz resonator structure.

Such a resonator can be achieved by using the structure of the guide cone without complex modification and without impairing the exhaust gas stream guidance performance.

Further, a Helmholtz resonator is particularly well suited to attenuating low frequencies, and this is highly advantageous in this instance because the low-frequency sound waves make a significant contribution to the formation of the noise. Moreover, the Helmholtz resonator is positioned close to the sources of noise allowing the sound waves to be attenuated “at source”, preventing them from spreading.

For preference, the guide cone comprises an interior resonant cavity into which extends a neck designed to place the resonant cavity of the guide cone in communication with the outside of the guide cone.

For preference also, the length of the neck, the volume of the resonant cavity and the cross section of the neck are adapted so that the resonant cavity of the guide cone resonates at a predetermined resonant frequency f, preferably below 400 Hz.

The resonator can be tuned so that its resonant frequency perfectly corresponds to the frequency of the sound waves that are to be attenuated.

According to one particular embodiment of the invention, the guide cone comprises an interior partition wall designed to limit the volume of the resonant cavity and to encourage this frequency matching.

According to another embodiment of the invention, the guide cone comprises at least one interior partition wall designed to compartmentalize the total interior volume of the guide cone into at least a first resonant cavity and a second resonant cavity respectively having a first resonant frequency f₁ and a second resonant frequency f₂.

For preference, the first and second resonant frequencies f₁, f₂ are different and below 400 Hz.

This treatment differs from an acoustic treatment inside the central body of a turbine engine nozzle as described in Snecma Patent Application FR-A-2 898 940. According to the treatment described in that patent application, the central body comprises a single resonant cavity communicating via a plurality of orifices along the wall with the annular stream of gas guided through the nozzle.

The invention will be better understood with the aid of the attached drawing in which:

FIG. 1 depicts a view in axial section of a helicopter turbine engine according to the prior art;

FIG. 2A depicts a view in axial section of a first embodiment of a guide cone according to the invention;

FIG. 2B depicts a view in axial section of a second embodiment of a guide cone according to the invention;

FIG. 2C depicts a view in axial section of a third embodiment of a guide cone according to the invention; and

FIG. 2D depicts a view in cross section of another embodiment of a guide cone according to the invention.

A helicopter turbine engine 1 comprises, from upstream to downstream, a compressor 2, an annular combustion chamber 3 and an axial free turbine 4 which recovers the energy of combustion to drive the wing structure of the helicopter, particularly the blades of the rotors. The exhaust gases resulting from the combustion are discharged from the engine by a circumferential exhaust nozzle 5 formed downstream of the free turbine 4.

The free turbine 4 ends at its downstream end in a hollow axial frustoconical component. This component, with the nozzle, performs a function of guiding the stream of exhaust gases to ensure that the stream flows in a healthy aerodynamic manner without creating turbulence as it leaves the free turbine.

In a first embodiment of the invention, with reference to FIG. 2A, the hollow axial frustoconical component or guide cone 7 is in the form of a shell of revolution comprising an upstream transverse wall 72 in the form of a disk and a downstream transverse wall 74 in the form of a portion which in this instance is concave but which could be convex or flat, connected by a frustoconical lateral surface 73 to the upstream transverse wall 72.

The hollow axial frustoconical component 7 in this first embodiment delimits a single interior cavity 71, known as a resonant cavity 71, into which extends a resonant neck 75, one end of which opens into the resonant cavity 71 and the other end of which opens on to the lateral surface 73 of the cone 7 via an orifice 76. In this embodiment, the resonant neck 75 is in the form of a right cylinder of circular section but it goes without saying that a rectangular or oval cross section could also suit, the cross-sectional area being adapted so that the axial frustoconical component 7 forms a Helmholtz resonator designed to attenuate the sound waves emanating from the engine.

What happens is that the axial frustoconical component 7 constitutes a noise suppression system of the “spring-mass” type, capable of greatly attenuating sound waves of given resonant frequency. The resonant frequency of the resonator formed by the axial frustoconical component 7 can be tuned according to the volume of the cavity, the length of the neck in the cavity, and the cross section of the neck. Thus, advantageously, the sound waves emitted by the engine and of a frequency close to that of the resonator are attenuated by the axial frustoconical component 7, thus reducing engine noise.

For preference, the axial frustoconical component 7 is particularly well suited to attenuating low-frequency waves, which means waves with frequencies below 400 Hz. This is highly advantageous because it is the low-frequency waves that chiefly contribute to engine noise.

Given that the resonator is incorporated into the engine, the sound waves are attenuated at the source that emits them, thus preventing the sound waves from spreading.

In a second embodiment of the invention, with reference to FIG. 2B, the axial frustoconical component or guide cone 8 is compartmentalized, an interior partition wall 87 delimiting a first resonant cavity 81 and a second resonant cavity 81′, the partition wall 87 in this embodiment being substantially perpendicular to a transverse plane.

This partitioning can be done in such a way as to obtain two longitudinal cavities, but can also be done as illustrated in FIG. 2B using a partition wall positioned parallel to the axis. In point of fact only the volume of each cavity thus formed contributes to controlling the tuned acoustic frequency: it is mechanical constraints that will dictate the form that the partitioning takes, the acoustic objectives fixing the volumes of each cavity.

Still with reference to FIG. 2B, a first resonant neck 85, one end of which opens into the inside of the first resonant cavity 81 and the other end of which opens into the lateral surface 83 of the cone 8 via an orifice 86, extends into the first resonant cavity 81. Similarly, a second resonant neck 85′, one end of which opens into the inside of the second resonant cavity 81 and the other end of which opens into the lateral surface 83 of the cone 9 via an orifice 86′, extends into the second resonant cavity 81′.

As depicted in FIG. 2B, the volumes of the resonant cavities 81, 81′ and the lengths and cross sections of the necks 85, 85′ are different here so that each compartment of the cone 8 forms a Helmholtz resonator each having its own resonant frequency.

In this example, the axial frustoconical component 8 has two resonant frequencies f₁ and f₂ of similar values so as to attenuate sound waves over a pass-band of a width comprised between f₁ and f₂. By way of example, the guide cone is able to attenuate frequencies comprised between 250 Hz and 350 Hz.

It goes without saying that the resonant frequencies f₁ and f₂ can also be chosen to correspond to the most critical frequencies in the engine noise frequency spectrum. Thus, the waves that make a significant contribution to engine noise are attenuated directly by the axial frustoconical component 8.

The resonant frequencies f₁ and f₂ of the hollow axial frustoconical component 8 can advantageously be tuned by altering the position of the partition wall 87 and/or by altering the length and cross section of the neck 85, 85′ in each of the resonant cavities 81, 81′.

The hollow axial frustoconical component 8 is able simultaneously to guide the stream of exhaust gas leaving the free turbine while at the same time forming a Helmholtz resonator with several tunable frequencies. A resonator such as this has the advantage of being fully incorporated into the engine, without increasing the size thereof.

With reference to FIG. 2C which depicts a third embodiment of the invention, the hollow axial frustoconical component or guide cone 9 is modified to increase the overall volume of the guide cone 9. That makes it possible to lower the resonant frequency of the resonator while at the same time maintaining correct attenuation quality. This works because the resonant frequencies of the guide cone 9 are inversely proportional to those connected with the volume of the resonant cavities as delimited by the interior partition wall 97.

A frustoconical component 9 of greater volume broadens the range for tuning the resonant frequency, or frequencies, of the resonator.

Altering the volume of the cone presents no disadvantage because the cone merely guides the stream of exhaust gas.

Axial frustoconical components comprising one to two compartments have been described, but is goes without saying that an axial frustoconical component or cone according to the invention could comprise more than two compartments so that the resonator has more than two resonant frequencies.

As depicted in FIG. 2C, the downstream transverse wall of the axial frustoconical component 9 may be convex, the shape of the cone being the result of a compromise between its mass, its guidance performance and its noise attenuating performance.

Another embodiment is shown in FIG. 2D which depicts a view in the axial direction of an alternative form of embodiment. The interior volume of the guide cone 19 is subdivided into three compartments by longitudinal partition walls 107, 107′ and 107″ arranged radially in a Y-shape. Resonant necks 105, 105′ and 105″ are designed to form the resonant cavities 101, 101′ and 101″ associated with the compartments.

1-7. (canceled)

8. A gas turbine engine through which gases flow from upstream to downstream, comprising:
a combustion chamber;
a high-pressure turbine positioned downstream of the combustion chamber configured to receive combustion gases emanating from the combustion chamber; and
a free turbine and a cone for guiding the exhaust gases which is fixed to the free turbine downstream thereof, the turbine engine emitting sound waves as it operates,
wherein the guide cone comprises an interior resonant cavity into which extends a neck configured to place the resonant cavity of the guide cone in communication with an outside of the guide cone to form a noise attenuator having a Helmholtz resonator structure, configured to attenuate the sound waves emitted by the turbine engine.

9. The turbine engine as claimed in claim 8, in which a length of the neck, a volume of the resonant cavity and a cross section of the neck are configured so that the resonant cavity of the guide cone resonates at a predetermined resonant frequency f.

10. The turbine engine as claimed in claim 9, in which the resonant frequency f is below 400 Hz.

11. The turbine engine as claimed in claim 8, in which the guide cone comprises an interior partition wall configured to limit a volume of the resonant cavity.

12. The turbine engine as claimed in claim 8, in which the guide cone comprises an interior partition wall configured to compartmentalize a total interior volume of the guide cone into at least a first resonant cavity and a second resonant cavity respectively having a first resonant frequency f1 and a second resonant frequency f2.

13. The turbine engine as claimed in claim 12, in which the first and second resonant frequencies f1, f2 are different and below 400 Hz.

14. The turbine engine as claimed in claim 12, the guide cone of which comprises more than two partition walls.
